(19) United States
(12) Patent Application Publication
(10) Pub. No.: US 2002/0083532 A1
(43) Pub. Date: Jul. 4, 2002

(54) Anionic coloring agents to dye leather, paper, cardboard and textile substrates: mixtures of coloring agents including these new products, and substrates dyed using the above coloring agents

(76) Inventor: Jorge Mazza, Buenos Aires (AR)

Correspondence Address: DARBY & DARBY P.C., 805 Third Avenue, New York, NY, 10022, US

(21) Appl. No.: 10/023,962

(22) Filed: Dec. 18, 2001

(30) Foreign Application Priority Data
Dec. 18, 2000 (AR) P00 01 06734

(51) Int. Cl. D06P 3/32; C09B 1/00; D06P 1/00; C09B 47/04; C09B 3/00; C09B 5/00; C09B 6/00

(52) U.S. Cl. 8/436; 8/636; 8/662; 8/675; 8/661; 8/657; 8/437; 8/917; 8/918; 8/919

(57) ABSTRACT

Anionic coloring agents comprising at least one spacer arm bounded to their chemical structure. These anionic coloring agents have the following general formula: C_{A}-B_{E}, wherein, C_{A} is an anionic coloring agent comprising at least a cromophore group; and B_{E} is the spacer arm, which has the following chemical structure: —(X—R—Z)ᵣ, wherein X is a direct link or a group having the formula —S(O)ₛ, wherein s is 0, 1 or 2; or —NR₁—, wherein, R₁ is hydrogen or a C₁-C₁₀ alkyl group; R is a C₁-C₁₀ straight or branched alkylene group: Z is a polar group; and r is an integer equal or higher than 1.

The invention also refers to coloring compositions, which comprise at least one anionic coloring agent of the formula C_{A}-B_{E} in admixture with anionic coloring agents which do not comprise spacer arms. Moreover, the invention reveals the use of the anionic coloring agents and said coloring compositions comprising them to dye cotton and wool substrates, regenerated cellulose, leather, cardboard and paper.

The introduction of spacer arms in the structure of anionic coloring agents leads to modified anionic coloring agents, which differ from the known coloring agents in their dying properties such as strength, tone and affinity, due to fixation modifications onto the substrate to be dyed.

### BACKGROUND OF THE INVENTION

Since the time when synthetic organic coloring agents were discovered at the end of the last century, they have been developed surprisingly. It is estimated that today there are more than 10.000 coloring agents which are or else have been used for industrial applications. It is to be remembered that the main application of these products comprises coloring a number of substances and materials of different origin, which without said coloring would not have such a pleasant appearance.

The discovery of synthethic organic coloring agents, and in particular of those having bright tones and which are cheap, has brought about a real social revolution, improving color, the general aspect and the warmth of our environment. The world around us has changed for the better since the moment said agents appeared.

It should be observed that before synthetic organic agents were discovered bright colors were obtained from very high cost natural colors, whose production was, moreover, highly polluting. Due to their high cost, applications used to be limited, and bright colors (bishop's purple, Tiro's purple) were then only an exception for grey and ocher which were commonly found in daily life.

Synthetic organic colors are used to color a large number of substrates having different compositions: plastics, textile materials, paper, leather, paints, printing inks, etc. Each substrate has a particular group of coloring agents. These, in turn, have either chemical groups or functions, which are responsible for the color, which are called “chromophores”. The most common ones have an azoic, anthraquinonic, formazanic, dioxacinic or ftlacianinic structure, etc. According to the complete molecular structure of the coloring agent, and not only on the structure of the chomrophore, coloring agentes can be classified as direct, acid, reactive, disperse, and organic pigments, etc. As mentioned above, there are specific coloring groups for each substrate. Thus, for example, the best coloring agents to dye cotton fibers are totally different from those used to dye woollen fibers, or acetate or polyester fibers. And, of course, they are totally different from those used to color poliethylene, PVC or poliurethane films.

Another variable to be taken into account is the color desired. For each substrate, each different color derives from one or several chemical structures and chromophores which can be different from those that create other colors. Consequently, there are, hundreds of different possibilities, which in turn justifies the need for further and constant research in this field.

As time went by, coloring agents were improved in order to enhance their properties as regards applications on traditional substrates, and also to adapt them to the new substrates that appeared later on.

The hundreds of new patents that have been issued in the last decades are substantial evidence of permanent research and development in this field. Said patents are related, on the one hand, to the search for new chemical structures and families for new coloring agents, and also to the modification of the already existing structures, in order to enhance some of their properties.

The most important properties may vary according to the composition and structure of the substrate on which the coloring agents will be applied, but some of them, such as dye yield, easiness of application and different degrees of strenght (under the effect of light, bleeding in different materials, etc), are always fundamental.

All these properties are related, in one way or another, to one fundamental property: the degree of fixation of the coloring agent on the substrate. This is vital, and there are dozens of patents whose main or only object comprises improving the fixation of a certain coloring agent on a given substrate.

For example, special reactive coloring agents to dye cotton are a particular case. A better fixation produces not only deeper shades of color, improves properties and degrees of strenght, but also allows the cleaning of the coloring agent that has not been fixed. Moreover, it has an ecological advantage, that is, it generates effluents which are less colored.

The same applies in the case of special coloring agents for leather, with one more variable: the coloring agent penetrates more or less depending on the thickness of the leather to be dyed. In brief: variation in fixation degrees of the coloring agent on a certain substrate represents habitually a change in some of the properties of said coloring agent once it has been fixed.

The applicant has been working and doing research for many years in order to develop new synthetic coloring agents, among them, several specific anionic coloring agents for the purification of proteins, such as those described and claimed in U.S. Pat. Nos. 5,597,485 and 5,876,597. The chormophores of said coloring agents are azo, anthraquinone, formazane, dioxazine and/or ftalacianine.

A specific development related to both patents is the use of “spacer arms” in the structure of each coloring agent, in order to enhance the fixation and selectivity of each coloring agent on proteins, which is particularly interesting in absorption cromatogarphy techniques and in dying processes in general.

Said spacer-arms are radicals or ordinary chemical groups bound to the molecules of coloring agents which modify some of their properties. One specific group of said spacer-arms are aliphatic chains, particularly hydrocarbonated chains including between 1 and 10 carbon atoms.

A novel aspect, also disclosed in said patents, is related to the discovery that the build-up of small quantities of coloring agents with spacer arms carried in coloring agents without said arms, improves the fixation of said carrier agents.

In this aspect, it is considered that the coloring agentes modified by the inclusion of said spacer-arms, behave as catalysts for the fixation reactions of coloring agents which do not comprise said spacer arms.

### Definitions

In the text that follows, the references to “spacer arms” or “brazos espaciadores”, correspond to either straight or branched C₁-C₁₀ alkylene chains, which carry polar terminal groups, bound to the structure of the coloring agent.

### The Invention

Anionic coloring agents are an object of this invention, and they are characterized in that they comprise at least one spacer arm bound to the structure of said coloring agents. Another object of this invention comprises the anionic coloring agents of claim 1, characterized in that they have the following formula:

C_{A}-B_{E}

Wherein:

C_{A} is an anionic coloring agent comprising at least a cromophore group; and

B_{E} is said spacer-arm, which has the following chemical structure:

(X—R—Z)

wherein:

X is a direct link or a group having the formula —S(O)ₛ,

wherein s is 0, 1 or 2; —NR₁—,

wherein R₁ is hydrogen or a C₁-C₁₀ alkyl group;

R is a C₁-C₁₀ straight or branched alkylene group;

Z is a polar group;

R is an integer equal or higher than 1.

Another object of this invention includes coloring compositions, which comprise at least one anionic coloring agent of the formula:

CA-BE

in admixture with anionic coloring agents which do not comprise spacer arms.

Another object of this invention includes the use of anionic coloring agents according to the claims below: to dye cotton, and wool substrates, regenerated cellulose, leather, cardboard and paper.

### DETAILED DESCRIPTION OF THE INVENTION

The present invention is based on the discovery that the introduction of anionic coloring agents with spacer arms in the molecular structure as defined herein, leads to other anionic coloring agents which are different as regards some dyeing property/ies; or for example: strenght, tone, affinity, etc.

Said replacement, in its broader aspect constitutes an application novelty for the modification of anionic coloring agents already revealed in the previous art as synthesis of new coloring agents. Therefore, the present invention allows the favorable modification of the properties of coloring agents already known, so as to produce and synthetize new anionic coloring agents.

Supposedly, the variation of properties is due to a variation in the fixing of the coloring agent on its corresponding substrate. Therefore, it is considered that these new molecules, comprising a new traditional coloring agent including one or more of the spacer-arms herein defined, as new coloring substances, which in some cases may include properties and degrees of strenght which make them different from the coloring agents traditionally used to generate new molecules.

Therefore, new coloring substances are obtained, unknown so far, which are the object of this patent. In particular, these new coloring substances are specially useful to dye fibers or fabrics totally or partially made of cotton, regenerated cellulose, polyester, nylon and wool, or else to dye leather, cardboard or paper.

The anionic coloring agents included in this invention are all those habitually used to color these substrates, that is, acid, direct, reactive coloring agents deriving from sulfur ? metalized or not.

The chromophores of these coloring agents are azo, anthraquinone, formazane, dioxazine and/or ftalocianine. The corresponding spacer arm must be included in the molecule of the original coloring agent, either by means of a chemical reaction or using an organic intermediary including said spacer arm for the synthesis of the final coloring agent. It has been found now, and this is the basis for the present invention, that the best spacer arms to change the properties of the coloring agents in question, when they are applied to the substrates above mentioned, are included in the following groups:

a) Chemical radicals of the following formula:

—(CH2)n—Z

where Z is a terminal group selected among amino, halo, cyano, hydroxil, carboxy, carboxamide and its derivatives N alkyl and dialkyl, and n is an integer between 1 and 10.

b) Chemical radicals of the formula:

—NY—(CH2)n—Z′—

where Z is a terminal group selected between halo, cyano, hydroxil, carboxy, carboxamide and its derivatives N-alkyl and dialkyl, sterified carboxyl, sulfide bound to an alkyl radical or hydrogen, and n is an integer between 1 and 10.

Y is an alkyl radical including between 1 and 10 carbon atoms, or else a hydroxiethyl radical, or else hydrogen.

c) Chemical radicals of the formula

NY—(CH2)n—NR1′R2′

where n is an integer between 1 and 10,

Y is an alkyl radical including between 1 and 10 carbon atoms, or else a hydroexiethyl radical, or else hydrogen;

And R1′ and R2′ is an alkyl radical including between 1 and 10 carbon atoms, or else hydrogen.

d) Chemical radicals of the formula

NY—(CH2)n—NR3—(CH2)2—X

where X=COOR4, CONH2, CN or SO3H, n is an integer between 1 and 10,

Y is an alkyl radical between 1 and 10 carbon atoms, or else a hydroxiethyl radical, or else hydrogen;

and R3 and R4 is an alkyl radical including between 1 and 10 atoms of carbon, or else hydrogen.

e) Chemical radicals of the formula

NY—(CH2)2—W

where W is a terminal group selected between —S—SO3R5 and —SO3R6 wherein R5, and R6 are alkyl groups including between 1 and 10 carbon atoms, or else hydrogen.

Y is an alkyl radical including bwtween 1 and 10 carbon atoms, or else a hydroxiethyl radical, or else hydrogen.

The alkyl chain —(CH2)n— mentioned above can be either straight or branched.

The altered coloring agents which are the object of this patent typically include only one spacer arm, but they can also include two or more, either similar or different spacer arms.

Moreover, when even a small amount of coloring agent including a spacer arm is added to a coloring agent or mixture of coloring agents which does not include said arms, the properties of the mixture are altered.

In brief: when dyeing fibers or fabrics totally or partially made of coton, regenerated cellulose, polyesther, nylon and/or wool, or when dyeing leather, cardboard or paper, the spacer arms mentioned above included in the molecule of each coloring agent typically used in this process can alter some properties of the substrate dyed with the typical coloring agent. The following examples included as an illustration only, show how the present invention can be embodied. The references to parts of components, reactive agents, etc correspond to parts in weight.

### EXAMPLES

### Example 1

38,3 parts of 2-naphtilamino-3,6,8-trisulfonic acid are diazoated as usual, and coupled with 15,2 parts of 3-ureidoaniline previously dissolved in 115 parts of water at 50° C., treated with 30 parts of sodium bicarbonate and ice-cooled at 0-3° C.

When the coupling is finished one part of disperser, 140 parts of ice and 19 parts of cyanuril chloride are added, and then stirred for 90 minutes at a pH of 6,5-6,7. Then, it is treated with 18,8 parts of m-phenylendiamine-4-sulfonic acid dissolved in 80 parts of water with sodium hydroxide at a pH of 5,0-7,0, and then ice-cooled at 40° C. It is heated at 35-40° C., and stirred for one hour, keeping the pH at 6,5-6,7 by means of a 20% solution of sodium carbonate.

Then, 22,8 parts of 1,6-diaminohexane are added dissolved in 300 parts of water, and heated at 80-85° C. It is stirred for one hour at 80-85° C. The intermediary is precipitated with 10N hydrocloride acid at a pH of 1,5. The cake is dissolved in 900 parts of water with sodium hydroxide at a pH of 9, and then coupled with 28,2 parts of 4-aminophenyl-β-hidroxy-ethyl sulfone sulfate esther diazoated according to conventional methods. The pH is maintained at 9 with a 20% sodium carbonate solution.

The coloring agent is precipitated with potasium chloride and acidified with hydrochloride acid to reach a pH of 1,6. It is filtered, resuspended in 760 parts of water, adjusted to a pH of 4,7-4,8 with disodic phosphate, and dried.

A reactive coloring agent according to formula 1 is obtained. This coloring agent is similar to the one mentioned in Example 1, U.S. Pat. No. 5,484,899 shown in formula 2, except that it includes a spacer arm.

When this new coloring agent is used on cotton, according to any of the traditionl methods, the dyed material obtained exhibits a very good degree of strenght and general properties.

### Example 2

31,9 parts of 4-amino-5-hydroxi-2,7-naphtalenedisulfonic acid dissolved at a pH of 6,0-6,5 with sodium hydroxide in 100 parts of water are passed dropwise on a diazo of 17,3 parts of p-sulphanilic acid prepared according to the conventional methods.

The temperature is maintanied at 0-5° C. with ice; it is stirred for 16 hours. 26,3 parts of 4,4′-diaminosulfanilide are diazoated according to conventional methods, and coupled with the previous product previously dissolved with sodium hydroxide at a pH of 6,0-6,5, and ice-cooled at 0° C. It is stirred for 10-15 minutes, and then the pH is adjusted to 9,0 with 10% sodium hydroxide. It is stirred for 4 hours. Then, 10,3 parts of m-phenyldiamine are added, and stirred for 1 hour. It is ice-cooled once again to 0° C., and a solution of 19 parts of cyanouril chloride are addded in 50 parts of acetone. Stirring continues for 20 minutes, and the pH is adjusted to 7,0-7,5 with a 20% sodium carbonate solution. The product obtained is treated with 22,4 p of N,N-dimethil-propilenediamine, and heated at 80° C. The coloring agent is precipitated with potassium chloride. It is filtered and dried.

An acid coloring agent accordig to formula 3 is obtained. This coloring agent is similar to the one mentioned in Example 174, DE 2,245,835, shown in formula 4, except that a spacer arm is included.

When this new coloring agent is used on leather, according to any of the traditionl methods, the dyed material obtained exhibits a very good degree of strenght as well as very good general properties.

### Example 3

31,9 parts of 4-amino-5-hydroxi-2,7-naphtalenedisulfinic acid are dissolved in 100 parts of water at a pH of 6,0 with diluted sodioum hydroxide. 24,3 parts of 4-aminophenyl-N,N-dimethylpropilenediamineethylsulfone are suspended in 100 parts of water, 12 parts of 10N hydrochloric acid are added. The slurry obtained is then ice-cooled at 0° C., and diazoated with 7 parts of sodium nitrite as a 30% solution. It is stirred for one hour at 0-3° C., and the excessive nitrous acid is eliminated with sulfamic acid. At a constant temperature of 0-5° C. the solution of 4-mino-5-hidroxi-2,7-naphtalenedisulfinic acid is added dropwise on the previous diazo, and stirred for 16 hours. Moreover, 26,3 parts of 4,4′-diaminesulfanilide are diazoated according to conventional methods. The diazo obtained is added rapidly to the previous product after being dissolved wih sodium hydroxide diluted at a pH of 6,0-6,5 and ice-cooled at 0-1° C. It is then stirred for 10-15 minutes, and then its pH is adjusted to 9,0 with 10% sodium hydroxide. It is stirred for 4 hours. The product thus obtained is treated with 61,5 parts of Black sulphur 1 previously reduced in 76 parts of water with 31 parts of sodium hydroxide (48% solution) and 15,6 parts of dextrose for 3-5 hours a 90° C., and ice-cooled at 10° C. The coloring agent thus obtained is precipitated with potassium chloride, then filtered and dried.

A coloring agent derived from black to sulphur according to formula 5 is obtained. This coloring agent is similar to the one mentioned in EP 731,144 shown in formula 6, except that one of the spacer arms mentioned above is included.

When this new coloring agent is used on leather, according to any of the traditionl methods, the dyed material obtained exhibits a very good degree of strenght as well as very good general properties.

### Example 4

13,1 parts of -aminocaproic acid are dissolved in 100 ml of water at a pH of 10 with 48% sodium hydroxide and added on 39, parts of 4-sulfateethylsulfinic-2-aminofenol-5-sulfinic previously suspended in 150 parts of water and taken to a pH of 7 with sodium bicarbonate. It is heated to 60° C., and stirred for one hour. 22 parts of concentrated hydrochloric acid are added. The slurry thus obtained is ice-cooled to 0° C., and diazoated with 7 parts of sodium nitrite as a 30% solution. It is stirred for one hour at 0-3° C., and then the excess nitrous acid is eliminated with sulfamic acid. The diazo thus obtained is coupled with 23,9 parts of 6-amino-4-hydroxi-2-naftalenesulfonic acid dissolved in 200 parts of water with 20 parts of sodium carbonate, and ice-cooled to 0° C.; the pH must not be under 7,5. Stirring continues for 2 hours. The pH of the slurry thus obtained is adjusted to 5,5 with a sufficient amount of acetic acid, it is treated with 13,8 parts of chromium acetate, and then heated to boiling point until metalization is complete. The product thus obtained is ice-cooled to 0° C.; 22 parts of 10N hydrochloric acid are added, and diazoated with 7 parts of sodium nitrite. It is stirred for 60-90 minutes at 0-3° C., and then the excess nitrous acid is eliminated with sulfamic acid. Finally, a solution of 8,85 parts of acetoacetanilide is added together with 5,45 parts of m-aminophenol in 100 parts of water with 4 parts of sodium hydroxide. The pH is adjusted to 9,0-9,5 with 10% sodium hydroxide. The coloring agent thus obtained is precipitated with potassium chloride, then filtered and dried.

A metalized acid coloring agent is thus obtained according to formula 7. This agent is similar to the one mentioned in Example 174, DE 3,805,746 shown in formula 8, except that one of the spacer arms mentioned above is included.

When this new coloring agent is used on leather, according to any of the traditionl methods, the dyed material obtained exhibits a very good degree of strenght and general properties.

Coloring agent according to EXAMPLE 1

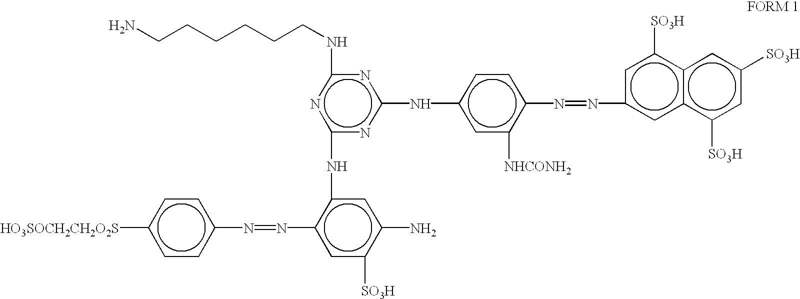

Example 1, U.S. Pat. No. 55,484,899

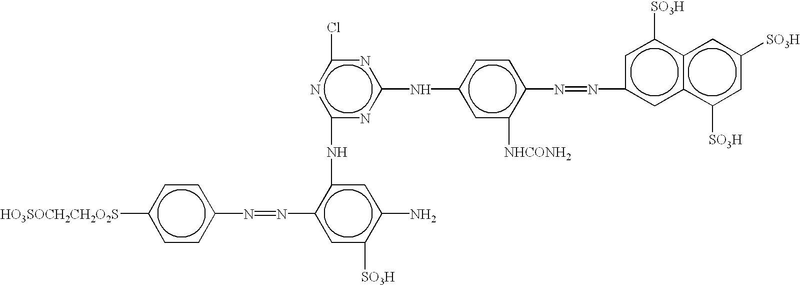

Coloring agent according to EXAMPLE 2

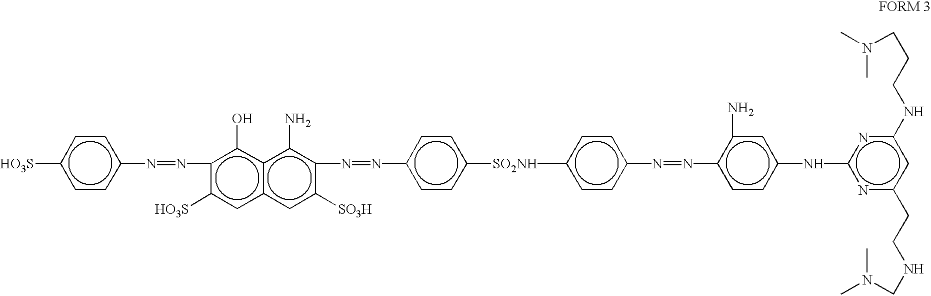

Example 174, DE 2,245,835

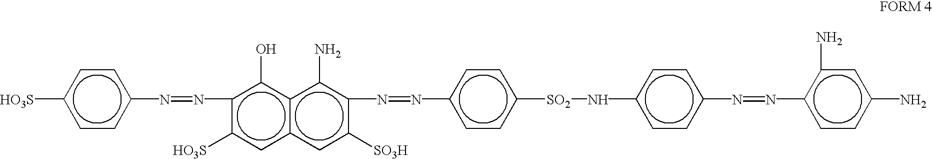

Coloring agent according to EXAMPLE 3

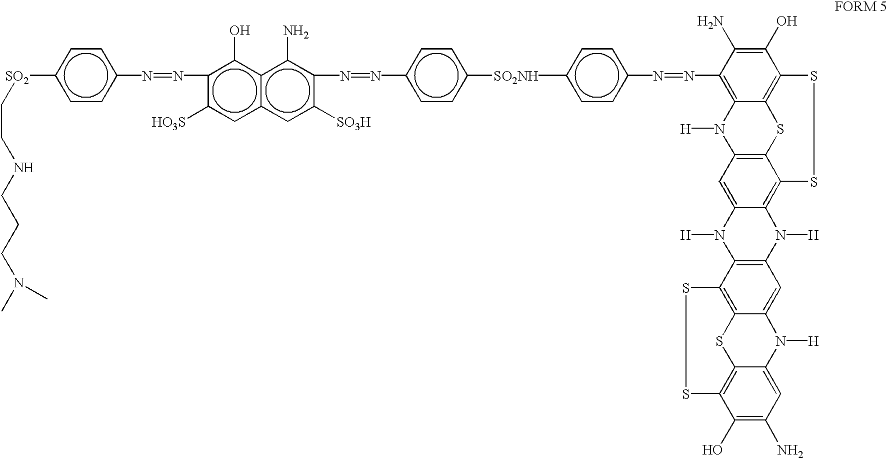

Example 1, EP 731,144

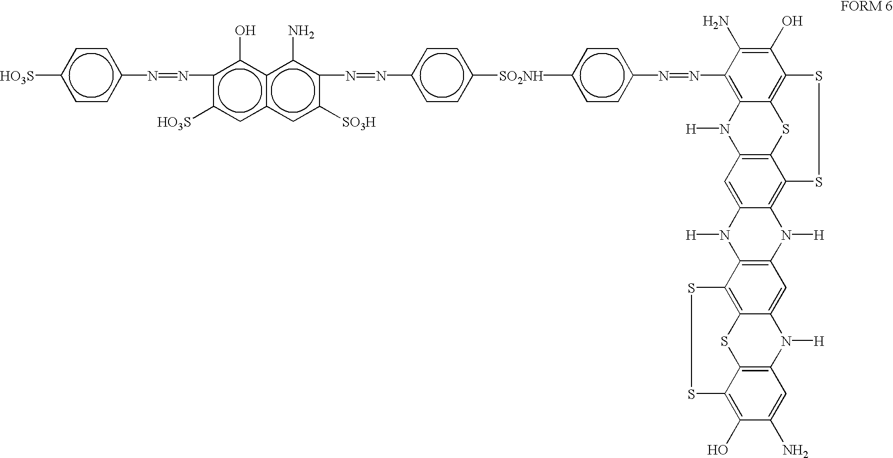

Coloring agent according to EXAMPLE 4

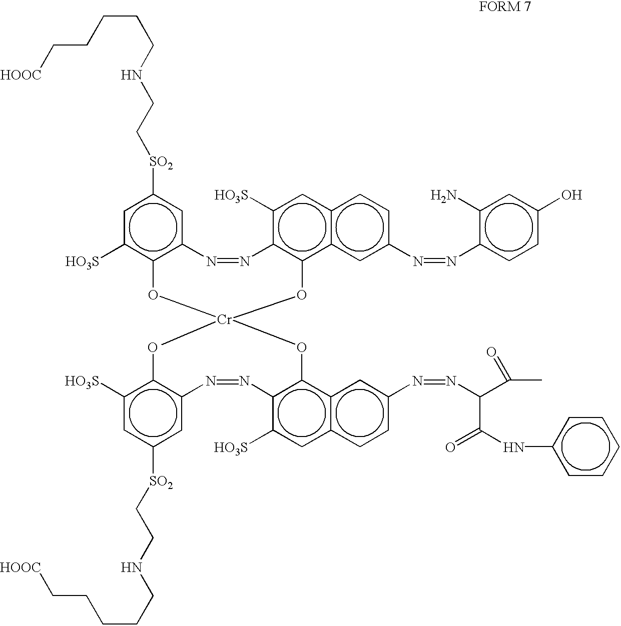

Example 2 DE 3,805,746

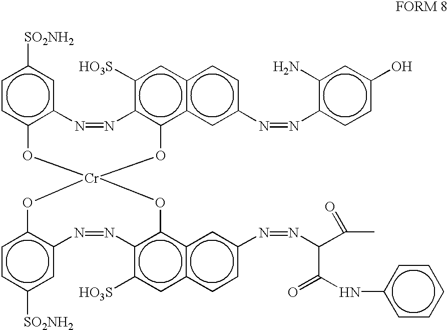

1. Anionic coloring agents characterized in that they comprise at least one spacer arm bound to the structure of said coloring agents.

2. Anionic coloring agents of claim 1 characterized in that they comprise the following formula:
C_{A}-B_{E}
Where:
C_{A} is an anionic coloring agent comprising at least a cromophore group; and
B_{E} is said spacer-arm, which has the following chemical structure:
—(X—R—Z)
where:
X is a direct link or a group having the formula —S(O)ₛ, wherein s is 0, 1 or 2; —NR₁—, wherein R₁ is hydrogen or a C₁-C₁₀ alkyl group;
R is a C₁-C₁₀ straight or branched alkylene group;
Z is a polar group;
R is an integer equal or higher than 1.

3. Anionic coloring agents according to claim 2, characterized in that said chromophores are selected from azo, anthraquinone, formazane, dioxazine, and/or ftalocianine, eventually metallized.

4. Anionic coloring agents according to claims 1 and 2, characterized in that said spacer arm corresponds to the formula:
—(CH₂)—Z
where:
n is an integer bewteen 1 and 10; and
Z represents a group selected among halo, amino, cyano, hydroxyl, carboxyl, carboxamide, and their N alkyl, dialkyl derived from C₁-C₁₀, and sterified carboxyl.

5. Anionic coloring agants according to claims 1 and 2, characterized in that said spacer arm corresponds to the formula:
—NY—(CH₂)ₙ—Z′
Where:
Z′ is hydrogen or a group selected from halo, cyano, hydroxyl, carboxyl, carboxamide, and their N alkyl and dialkyl derived from C₁-C₁₀, sterified carboxyl with C₁₋₁₀ alkyl, —SR²—, where R² is hydrogen or C₁₋₁₀ alkyl; and
N is an integer bewteen 1 and 10; anf
Y es hydrogen or an alkyl group or C₁₋₁₀ hydroxi alkyl.

6. Anionic coloring agents according to claim 5, characterized in that said spacer arm corresponds to the following structure.
—NY—(CH₂)ₙ—NR₁, R₂.
Where:
Y represents hydrogen, hydroxi alkyl or a group of C₁₋₁₀ alkyl;
N is an integer between 1 and 10; and
R₁ and R₂ either represent hydrogen or a C₁₋₁₀ alkyl group.

7. Anionic coloring agents according to claims 1 and 2, characterized in that the spacer arms comprise the following structure:
—NY—(CH₂)ₙ—NR₃—(CH₂)₂—X
Where:
Y represents hydrogen, hydroxi alkyl or a C₁₋₁₀ alkyl group;
X is a —COOR₄, —CONH₂, —CN or —SO₃H group;
N is an integer between 1 and 10; and
R₃ and R₄ either represent hydrogen or a C₁₋₁₀ alkyl group.

8. Anionic coloring agents according to claims 1 and 2, characterized in that the spacer arms comprise the following structure:
—NY—(CH₂)₂—W
Where:
Y represents hydrogen, hydroxi alkyl or a C₁₋₁₀ alkyl group;
W is a group selected from —S—SO₃R₆; where R₅ and R₆ either represent hydrogen or a C₁₋₁₀ alkyl group.

9. Anionic coloring agents according to any of the claims above, characterized in that they comprise more than one spacer arm.

10. Coloring compositions characterized in that they comprise at least one anionic coloring agent according to any of the claims above.

11. Coloring compositions according to claim 10, characterized in that they comprise, moreover, coloring agents without said spacer arms.

12. Use of anionic coloring agents according to claims 1 to 9, characterized in that they are used for the dyeing of substrates selected from fibers or fabrics including cotton, regenerated cellulose, nylon and/or wool.

13. Use of anionic coloring agents according to claims 1 to 9, characterized in that they are used for the dyeing of substrates selected from leather, cardboard or paper.

14. Use of coloring compositions according to claims 10 to 11, characterized in that they are used for the dyeing of substrates selected from fibers or fabrics including cotton, regenerated cellulose, nylon and/or wool.

15. Use of coloring compositions according to claims 10 to 11, characterized in that they are used for the dyeing of substrates selected from leather, cardboard or paper.

16. Substrates characterized in that they have been dyed according to claims 1 to 9.

17. Substrates characterized in that they have been dyed using the coloring compositions according to claims 10 and 11.
